(19) United States
(12) Patent Application Publication
(10) Pub. No.: US 2003/0046218 A1
(43) Pub. Date: Mar. 6, 2003

(54) System and method for protecting positions in volatile markets

(76) Inventors: Bernard J. Albanese, Towaco, NJ (US); Barry M. Mindes, Wayne, NJ (US)

Correspondence Address: PENNIE AND EDMONDS, 1155 AVENUE OF THE AMERICAS, NEW YORK, NY, 100362711

(21) Appl. No.: 09/972,480

(22) Filed: Oct. 5, 2001

Related U.S. Application Data
(60) Provisional application No. 60/238,193, filed on Oct. 5, 2000.

(51) Int. Cl. G06F 17/60

(52) U.S. Cl. 705/37

(57) ABSTRACT

This invention relates to novel options-based financial instruments, and a related system and method that automates market trading of the novel instruments. The invention protects positions against short-term market movements by inducing users on the opposite sides of a transaction to trade in equal or near equal dollar volumes. The system includes an automated price quotation capability for the instruments, that operates at computer speeds, without human intervention—specialists and market makers are not necessary. Through the use of feedback techniques, the system induces traders on the opposite sides of a transaction to trade in near equal numbers of round lots, minimizing the system's financial exposure from unbalanced trading. The system also fully automates the trading of the financial instruments themselves, plus the attendant functions (inventory control, billing, reporting, etc.), so that users may interact with the system on-line, without human intervention. The novel financial instruments have the characteristic that they allow trading directly in the price movement of the underlying security (stock, bond, currency, etc.), while providing superior financial leverage as compared to investing directly in the underlying security.

### CROSS-REFERENCE TO RELATED APPLICATION

This is a nonprovisional application claiming the benefit of U.S. Provisional Patent Application Serial No. 60/238,193 filed Oct. 5, 2000, which is hereby incorporated by reference in its entirety.

### TECHNICAL FIELD

This invention relates to a novel options-based financial instrument, and a related system and method that automates market trading of the novel instruments. The invention protects a trading firm's positions against short-term market movements by inducing users on the opposite sides of a transaction to trade at equal or near equal balance.

### BACKGROUND OF THE INVENTION

In just the past few years, the U.S. equity markets have experienced the growth of electronic communications networks “ECNs,” the breathtaking expansion of Internet trading, and the National Association of Securities Dealer's acquisition of the American Stock Exchange. The New York Stock Exchange (“NYSE”) presently uses an outdated system that cannot respond to the simultaneous convergence of technology, competition between domestic and global markets, and regulation. The present invention addresses these three concerns by providing an automated market trading system, which can react to rapid, short-term movements in markets on a real-time basis.

Specialists

Buyers and sellers on the NYSE are desperately in need of a system that can handle their trades on a real time basis. The specialist is a dealer for one or more listed common stocks, and manages the auction market in those specific securities allocated to him. The specialist is central to the NYSE; NYSE specialists disseminate information to market participants by displaying price schedules consisting of quoted prices and depths for both the bid and the ask sides of the market. Every time a broker wants to make a trade of a certain size, he makes his way to the appropriate trading post on the trading floor and finds the responsible specialist for the company whose stock he wants to trade. The main job of specialists and similar but less formally-empowered trading functionaries, such as market makers, is simply to match investors' orders to buy stocks with orders to sell them.

Trades on the stock market are made when bid and asked prices that traders on the two sides of the transaction are willing to accept are in agreement. The specialist acts as auctioneer between buyers and sellers, but the specialist can also buy and sell shares himself. Indeed, if there are more orders to sell a particular stock than to buy it, the specialist firm is required to step in with its own money and buy that stock, cushioning the stock's descent by paying gradually declining prices. The specialist must also sell his stocks if there is an excess of buy orders. While buying or selling stock for his account, the specialist will simultaneously change the bid and asked prices previously quoted. This will be done, as usual, to induce traders to buy or sell shares in the manner needed to bring trading into balance. But the specialist is not supposed to buy or sell if doing so would interfere with fair and orderly trading. Specialists must serve as the buyer or seller of last resort in order to maintain a competitive and efficient market. This means that all customer orders have an equal opportunity to interact and receive the best price. In return for meeting these obligations, the specialist is allowed near-complete knowledge of how much buying pressure and how much selling pressure there is. A specialist also can impose order on a chaotic situation. If suddenly flooded with sell or buy orders the specialist can, under some circumstances, ask that trading be halted until everyone has a chance to absorb the events that caused it.

The present invention addresses one of the major problems presented by markets using human specialists, namely, that because of the inherent response time limitations of a human system, they cannot react quickly enough to changes in market condition. Specialists cannot work fast enough to generate the quotes that match up the buyers with the sellers (or to execute the trades themselves, when appropriate). When a buyer enters an order into the “SuperDot” (the electronic order handling facility or “trading engine” of the NYSE), there are several things that can happen. If the order is “marketable” (i.e. an order to buy or sell a predetermined number of shares immediately at the best available current price, with no price restrictions) and the stock is currently available, the order may be presented to the exchange as a “Direct” order and will be executed at electronic speed. If the order is a limit order (i.e., an order to buy or sell a predetermined number of shares at the specified price or better), and the result is a partial fill (i.e., not all of the predetermined number of shares can be transacted), the remainder will go into the specialist's book. On the other hand, if the order is an “out of the market” limit order (i.e. one in which no shares can be transacted based on the price restrictions), it will go directly into the specialist's book. However there is another category of orders which will not stay in SuperDot but will rather be printed out onto paper in the specialist's post. The specific types of orders that get printed out and handled manually by the specialist on the NYSE include sell-short-stop orders, immediate-or-cancel orders, fill-or-kill orders, and all-or-none orders. The specialist must hand-retrieve such orders and “baby-sit” them until execution.

Order handling rules on the NYSE are different from the National Association of Securities Dealers Automated Quotation system (“NASDAQ”). On the NASDAQ, market makers are required, for example, to respond to a SelectNet (the electronic trading engine for NASDAQ) preference in 30 seconds or less. But even this NASDAQ requirement is slow compared to speeds theoretically achievable with a fully computerized trading system. In contrast to the NASDAQ rule, on the NYSE, when an order is to be monitored by the specialist by hand, there is no set time in which he must respond. Combined with the facts that the orders are printed on paper (and thus subject to being misplaced), and that specialists are generally extremely busy, such manually processed orders may fall through the cracks and not be executed in a timely fashion.

Thus, an investor, or market participant, who places an order that is manually processed by a specialist must closely monitor his order to ensure proper processing. If a stock trade occurs, but his order remains in limbo, the participant must call his broker immediately and ask for the “status” of the order. The broker will then call the member firm, which will in turn check the order's status with the specialist.

The specialist must constantly monitor all of the stocks he manages, all of the limit orders in the SuperDot, all of the manually-processed orders, and must at the same time also deal with the crowd on the trading floor. Specialist are human and thus will inevitably commit errors. This is a problem endemic to the specialist system, based on the current order-handling rules. Simply put, the digital age has sped the trading process up so fast that it has outrun the tried and true procedures on all exchanges, particularly those using specialists for trading, but also those that have quotes controlled by human beings.

Thus there is a need in the art for a system and method which will help update price quotations, order-handling procedures, and provide operational speeds faster than known systems, taking full advantage of computer technology.

The present invention seeks to induce equal trading on each instrument by changing the quoted prices of the instruments automatically, through the use of feedback and algorithms, to reflect the market at any given instant. In this way, the entity that is responsible for maintaining an orderly market (including being the buyer or seller of last resort) minimizes its financial exposure from unbalanced trading volumes, while allowing online trade transaction processing without human intervention.

Options

Generally stated, an option is a financial instrument which can be sold by one party to another that offers the buyer the right to buy (call) or sell (put) a security at an agreed-upon price (the “strike price”) during a certain period of time or on a specific date.

Specifically, a call option gives the holder the right to buy some number of shares, traditionally 100, of the underlying security at a specific price for a predetermined time. For example, the purchaser of a six-month call option on XYZ stock at $50 has paid for the right to buy XYZ at $50 a share at any time over the next six months. Conversely, a put option accords the holder the right to sell 100 shares of the underlying stock at the put's exercise or strike price for a predetermined period. Thus the purchaser of a six-month put option on XYZ stock at $50 has paid for the right to sell XYZ at $50 a share any time over the next six months. Conversely, if it were a call option, the purchaser would have the right to acquire the stock at $50 a share for six months. So one would buy a call if they expected the stock to rise. One would buy a put if they thought the stock was going to decline. If the stock price holds steady or moves in the opposite direction, the amount paid for the option is lost completely.

Options are used by participants who want to leverage their investments. For example, a participant with $1,000, who thinks that the price of XYZ stock is going to go up could buy ten shares of XYZ stock at $100 per share. In this case, if the stock increases to $105 per share, the participant will have a profit of $50. But if the participant had bought $1,000 worth of call options in XYZ stock at $105, he might have been able (depending on the call pricing) to buy, say, options for 500 shares. In that case, the same increase in XYZ stock price (to $105) would result in a profit of $2,500.

The cost of these potentially great returns is of course the increased risk. If the stock price does not rise to the strike price in the predetermined time (i.e., finishes “out of the money”), the entire $1,000 investment is lost. In contrast, a participant who invested directly in the stock, rather than in options, can make a profit even if the stock price increases only slightly; for example, if the price increases to $104 per share, this participant would have a $40 profit. Indeed, a participant investing in the underlying stock will suffer only minor losses even if the stock price decreases (slightly); for example if the price drops to $95 per share, this participant would only lose $50.

An option holder runs the risk of losing the entire amount paid for the option in a relatively short period of time. The fact that options become valueless upon expiration means that an option holder must not only be right about the direction of anticipated price change in the underlying interest he must also be right about when the price change will occur. These investors are involved in highly unpredictable transactions.

Despite the high risk of options instruments, many investors choose to be exposed to those risks in light of the large potential gains. Furthermore, there are certain market conditions and business situations that make transactions in options a rational decision. Hedging an existing financial position is one such common situation. Thus there is a need in the art for a financial instrument that allows some participants to make money from price movement of a security while at the same time protecting other participants from losses in their investment if they have not correctly predicted the direction of future price movements.

As explained above, the problem that specialists face is that they cannot always act quickly enough to respond to market movements. The price of the underlying financial instrument may fluctuate up or down so quickly that the specialist does not have time to generate proper quotes rapidly enough to match the buyers with the sellers, thus causing instability in the market, and often causing the specialist losses when he is forced to buy or sell for his own account. Accordingly, there is a need for a system that allows participants and specialists who are interested in hedging against market swings to engage in trading activity, while at the same time maintaining stability in portfolio values. The present invention achieves this by producing effectively instantaneous changes in the price of the instruments and thus counteracts the rapid movements in the price of the underlying financial instruments.

On-line trading, programmed portfolio positioning, and high-speed, worldwide exchange of information has all contributed toward making markets much more volatile. Daily one hundred point or greater movements in market indices, two percent changes in stock prices, even percentage changes in currency rates now often happen monthly, weekly, or even daily. The previously useful financial instruments and strategies for protecting positions and maintaining value need radical improvement to counteract the rapid, short-term movements in markets that are now pervasive. Thus there is a need in the art for counter-measures that can be applied on a time frame consistent with the market fluctuations, and which provide protection against potential short-term market movements, both on the up side for bears, and on the down side for bulls. There is also a need for a convenient new vehicle for trading securities and other financial instruments (stocks, bonds, currency, etc.) with maximum ease and leverage, and at minimum expense, in an on-line trading environment.

Prior art examples of matching systems used in connection with the trading of trading instruments are disclosed in U.S. Pat. No. 3,573,747, which discloses an anonymous trading system for selling fungible properties between subscribers to the system; U.S. Pat. No. 3,581,072, which discloses the use of a special purpose digital computer for matching orders and establishing market prices in an auction market for fungible goods; U.S. Pat. No. 4,412,287, which discloses as an automated stock exchange in which a computer matches buy and sell orders for a variety of stocks; U.S. Pat. No. 4,674,044, which discloses an automated securities trading system; and U.S. Pat. No. 5,136,501, which discloses an anonymous system where bids are automatically matched against offers based on the credit limit between the potential parties.

U.S. Pat. No. 5,573,244 discloses a method for wagering at fixed handicaps and odds on a sports event. Specifically, a data processing system and method is described that allows a betting “house” to maintain a betting pool on a contest by controlling the terms (the betting odds and/or handicaps) for the contestants so that bettors are encouraged to place bets that will bring the betting pool (the “book”) into balance, thereby minimizing the house financial exposure. U.S. Pat. No. 5,842,921 discloses various improvements on that system and method, including: (i) the “hedging” of bets in light of changing betting terms, such that bettors can guarantee profits or minimize losses before the contest is complete; (ii) placement of incoming bets in a queue before being processed, such that those bets' effect on pool balance can be evaluated before accepting or rejecting the bets; (iii) accepting incoming bets in the queue only in matching sets, so as to prevent any imbalance of the betting pool; and (iv) rejecting bets, and providing an accompanying indication of the change in betting terms which would be required if the bets are to be accepted.

However, none of these prior art systems teaches or suggests the use of a real time system using a new security, which is essentially a pair of put/call options, that changes the price of the security automatically to induce traders on the opposite sides of at transaction to trade in equal or near equal numbers of round lots.

### SUMMARY OF THE INVENTION

The present invention provides a novel financial instrument, and a system and method for trading in these instruments. The system and method will tend to bring a market trading in the instruments into balance between buyers and sellers through automated means.

These new instruments, called “Directional instruments,” change in value in direct concordance with a linked security (stock, bond, currency, etc.), referred to herein as the “underlying security.” The Directional instrument has no intrinsic value initially, but only achieves an intrinsic value (which can be either positive or negative) as its price changes relative to its initial price—these price changes mirror changes in the price of the underlying security.

In the embodiment described herein, a pair of Directional instruments called “Ups” and “Downs” are described. The Ups and Downs are essentially co-joined pairs of puts and calls. However, the description using Ups and Downs is merely illustrative, as the present invention can be practiced equally well using other types of instruments having the required characteristics (namely, having a price which is correlated to the price of an underlying item, while effectively maximizing financial leverage as compared to investing directly in the underlying item).

The Up/Down embodiment of the novel financial instruments of the present invention represents a new security comprising a paired put and call option. The novel instruments are for use in real-time transactions on equities, indices, exchange rates, bond prices, or any other financial or related instruments that trade in reasonably large volumes and are subject to large, rapid, short-term swings in prices. These instruments are useful for traders, specialists, market makers, and financial institutions interested in hedging positions against such market swings so as to maintain stability in portfolio value. They also provide a new capability to better accommodate those investors whose trading activity makes such hedging strategies possible, i.e., high-risk investors and speculators.

The novel financial instruments of the present invention preferably operate in conjunction with an on-line, real time, system that changes prices automatically to induce traders on the opposite sides of a transaction to trade in equal or near equal numbers of round lots. In the case of unequal trading volumes, the system can automatically maintain the imbalance below a pre-set maximum, either an absolute value or a percentage level.

One embodiment of the novel trading system of the present invention comprises a method of trading investment instruments relating to an underlying item. The method includes the creation of an Up instrument by aggregating: (i) the purchase of a round lot of call options for the underlying item at a specified strike price and specified expiration date/time, and (ii) the sale of a round lot of put options for the same underlying item at the same strike price and same expiration date/time, and the creation of a Down instrument by aggregating: (i) the purchase of a round lot of put options for the underlying item at a specified strike price and specified expiration date/time, and (ii) the sale of a round lot of call options for the same underlying item at the same strike price and same expiration date/time. The opening sale price for the Up and Down instruments is calculated, then the Up and Down instruments are opened to trading at their opening sale prices. The system monitors the sales of the Up and Down instruments; parameters which may be monitored include price movements, rates of change in price movements, the imbalance in the trading volume of Up and Down instruments, expected statistical distributions of buyer sentiment as a function of price, previous trading history, and information relating to the order book (if limit orders are accepted). The sale price of the Up and Down instruments are adjusted based at least in part on information collected in the monitoring step.

### BRIEF DESCRIPTION OF THE DRAWINGS

The features and advantages of the present invention will become more readily apparent from the following detailed description of the invention in which like elements are labeled similarly and in which:

FIG. 1 is a schematic system diagram of a system according to the present invention;

FIG. 2 is a generalized logic flow diagram of the initial processing flow of a system according to the present invention;

FIG. 3 is a generalized logic flow diagram of the processing flow relating to recalculating instrument prices based on changes in price of the underlying security in a system according to the present invention;

FIG. 4 is a generalized logic flow diagram of the processing flow relating to order execution and the adjustment of instrument prices in a system according to the present invention; and

FIG. 5 is a generalized logic flow diagram of order processing in a system according to the present invention.

### DETAILED DESCRIPTION OF THE PREFERRED EMBODIMENTS

The system can be best understood from an illustrative example using a specific stock or index. Consider that there is a market index that is at 1000 momentarily. The system offers two instruments on the index. These are referred to as the “Up” instrument and the “Down” instrument, or collectively as “Directional” instruments. The Up instrument is a combination or aggregation that comprises the simultaneous buying of a call and the selling of a put, both at the current index value of 1,000 and both having the same expiration date/time. Conversely, the Down instrument comprises the simultaneous buying of a put and the selling of a call at the same current index value of 1,000 and both having the same expiration date/time.

Now, consider that the index moves from 1,000 up to 1,005. The holder of an Up instrument will have a 5 unit gain from the call that he bought; since the index increased to 1,005, the right to buy at the lower strike price of 1,000 represents a profit of (1,005-1,000). However, the put that he sold has finished out of the money and thus has no profit or loss effect; since the index went up to 1,005, the purchaser of the put will simply not exercise his option to sell at the lower strike price of 1,000. Overall, the holder of the Up instrument will have a paper profit of 5 units.

Conversely, the holder of the Down instrument in the same market will have a 5 unit loss from the call he sold; since the index went up to 1,005, the purchaser of the call will exercise the right to buy at the lower strike price of 1,000. The put that the holder of the Down instrument purchased has finished out of the money, so he will not exercise his option. Thus, overall, the holder of the Down instrument will have a paper loss of 5 units.

Similarly, if the index went from 1,000 down to 995, the holder of the Down instrument would have a paper profit of 5 units (1,000-995) and the holder of an Up instrument would have a paper loss of 5 (995-1,000).

As can be seen from the previous examples, movements of one point up or down in the index produces gains or losses of one dollar in the Directional instruments. This is part of the mechanism through which these novel instruments are able to protect portfolio value. The nearly instantaneous change in the price of the Directional instruments completely, or almost completely, counteracts the rapid movements in the price of the underlying financial instrument.

These Directional instruments may also be offered on a “pseudo” index which is related to a real index. For example, it may be decided that the Dow Jones Industrial Average (“DJIA”) has fluctuations which are too large to base the Directional instruments on. One could then define a pseudo index which is always equal to one-tenth the DJIA. This would result in instruments which only moved $0.10 for each movement of one point in the DJIA.

The Directional instruments of the present invention are a new security type. But as they operate similarly to aggregated pairs of known puts and calls, their acceptance should be relatively easy. Furthermore, existing puts and calls cannot serve the same function as the present invention, as it is only through the use of the disclosed trading system, with its algorithm-driven feedback technology, that the required automation speed and trade balancing effects may be achieved. The new Directional instruments also fit in well with modern programmed trading practices.

The Directional instruments have prices for round lots of a specified number of instruments, for example, 100 instruments per lot. The trading system of the present invention automatically changes the lot prices in real time, so as to induce the users of the trading system (market participants including investors, brokers, traders, etc.) to trade such that the total numbers of round lots on the two sides (Ups and Downs) of the transaction are equal, or nearly equal, so as to minimize financial exposure by the operator of the trading system (specialist, exchange, market maker, etc.). The system uses computerized algorithms that consider a variety of data, including price movements, rates of change in price movements, dollar volume imbalances, expected statistical distributions of buyer sentiment as a function of price, previous trading history, and information relating to the order book (if limit orders are accepted), to automatically generate the appropriate prices to induce balanced trading.

These algorithms implement a feedback system controlling the instrument price to provide, in effect, an “automatic specialist” that can update prices at sub-second frequencies while considering a large number of factors. This performance obviously greatly exceeds human capabilities, and it is this capability which enables the system to track rapid fluctuations in the market.

As an example of how the system changes the instrument prices so as to induce equal participation, consider that the asked prices for round lots of 100 Directional instruments in the above example were initially set by the system at $100 each. Assume further that for some reason, a majority of the participants then act as if they expected that the index will increase. In this case, the dollar volume of offers made on the Up instruments will exceed those made on the Down instruments.

In order to create an orderly market and also to limit house financial exposure, there will be a predetermined maximum allowable volume imbalance set as a system parameter. When the system determines that the imbalance in the trading volume on the Up and Down instruments has exceeded this predetermined maximum allowable value, the system will no longer accept offers at $100. At that time, the prices of the Directional instruments will be separately adjusted so as to encourage relatively more volume of offers on Down instruments; in this example the prices might change to $104 on Ups and $96 on Downs. If that price change brings the market into balance, the prices remain unchanged. If, however, the changes are not precisely successful in attaining balanced trading, a subsequent additional change, for example to $108 for Ups and $94 for Downs, might be necessary. Note that as in the preceding example, it is not necessary for the price movements on the ups and downs to be equal. Through computer-based implementation of the price feedback control loop, the system will quickly reach the required level of trading balance through these price adjustments.

Having generally described the novel financial instrument and trading system of the present invention, now some specific examples of the physical and algorithmic implementation of the system and method of the present invention are provided below, including sample algorithms used in connection with the pricing of the novel financial instruments.

System Configuration

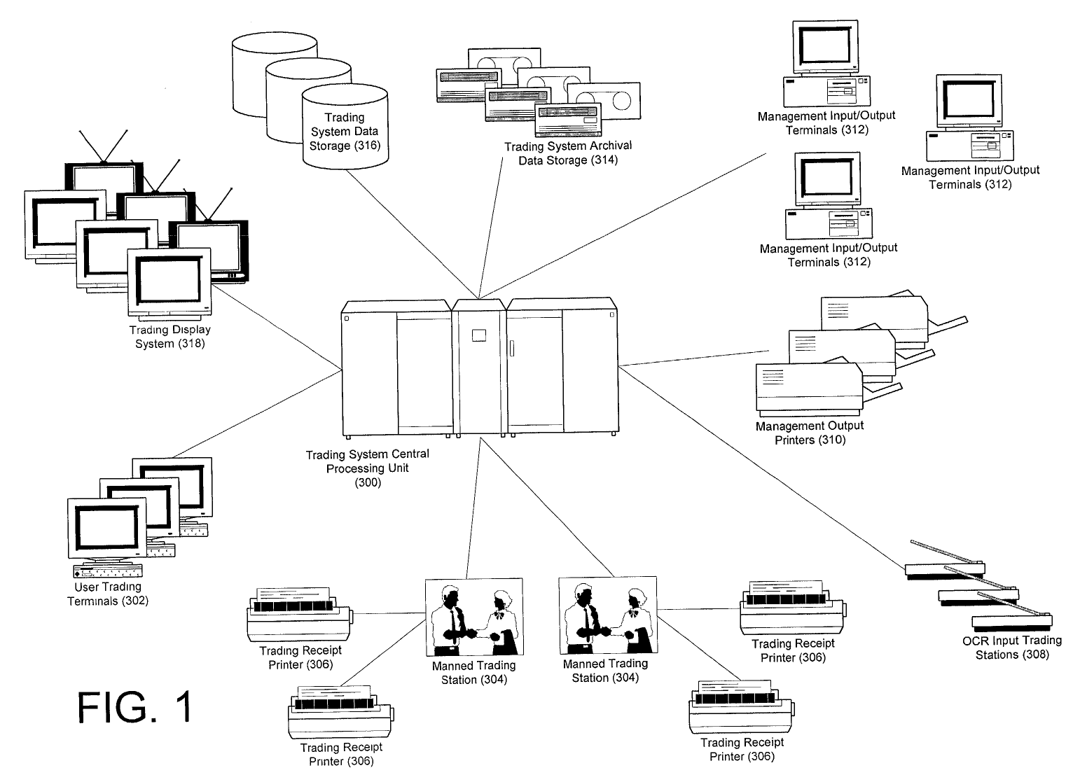

The present invention provides a data processing system and method for maintaining a market having certain transaction terms. The system and method according to the present invention is preferably implemented using computer hardware and software. In a preferred configuration, an apparatus according to the invention connects to a network of input and output devices and displays. FIG. 1 is a schematic diagram of a typical system configuration according to this invention. The system comprises multiple elements, including a trading system central processing unit 300 that processes trading data, calculates prices, opens and closes the sale of all instruments, controls all input and output devices, produces all management and analysis reports, and is the repository for all current and historical data on the trading system. Central processing unit 300 may include one or more processors, storages, control units and communication devices. It interconnects to input and output devices such as remote user trading terminals 302, optical character recognition (OCR) input trading stations 308, management output printers 310, management input/output terminals 312, trading system archival data storage systems 314 (which typically are magnetic tape or optical storage systems), trading system data storage systems 316 (which typically are magnetic disk storage systems), and trading display systems 318. The offers to buy may be entered into the system both by investors themselves at user terminals 302, which is the preferred use, but it is also amenable to use by traders or brokers at managed trading stations 304 (using personal computer terminals, not shown); the traders and brokers may issue receipts via trading receipt printers 306. Each user terminal 302 preferably comprises a personal computer running a “windowing” system, providing information regarding current and historical prices for trades the user has made, the user's account balance with the trading house, etc. The terminal will, most likely, also show a real-time display of current trade prices on the underlying stocks, bond, etc. User terminals 302 may also have associated printers (not shown).

User terminals 302 and PC terminals used at manned trading stations 304 could be local devices connected via hard wire, devices connected via a local area network, or devices connected via a common carrier network. User terminals 302 and PC terminals used at managed trading stations 304 are either keyboard or scanned input devices and user terminals 302 may also have cash or token payment capabilities. User terminals 302 may have displays which show historical prices, current values, or other information having to do with the details of the trades being made. These and/or other terminals can optionally be used as payment terminals to reimburse investors. Input through the common carrier network could also come from telephone key pads, voice recognition equipment or virtually any compatible input device.

In the case of user terminals 302, data relating to one or several financial instruments can be displayed in “windows” (partial screen displays) on the screen or occupy the entire screen, with current prices and historical price information being displayed simultaneously on the screen. The system can also be used in conjunction with trading data displays 318 showing the changing trading terms for the various instruments in a format visible to several users simultaneously.

The system can produce trading receipts for the investors which are output on printers, such as trading receipt printers 306. These receipts can optionally include optical reading marks for rapid reading, counterfeit protection codes, investor identification, and the total of all trades which are currently active for the player. There are also communication lines (not shown) for the receipt of relevant market data, in order to keep the system and users current on the status of the market in the underlying securities.

Computer Hardware, System Software, and Communications

Incorporated into a system according to the present invention are subsystems that use known hardware and software technology.

All of the subsystems are controlled by central processing unit 300, which also incorporates known hardware and software technology. For example, central processing unit 300 could, depending upon the specific size of an installation, use a Pentium, RISC, minicomputer, or mainframe-based processor. Units typically manufactured by companies such as IBM, Dell, Hewlett-Packard, and others, are entirely suitable. Similarly, disk storage systems from firms such as IBM and Maxtor, magnetic tape systems such as those from Storage Technology, and laser storage systems such as those from Sony are entirely adequate for the needs of the system.

The local entry keyboards and displays can be either dumb terminals (such as manufactured by IBM), workstations (such as manufactured by Sun), or standard PCs using Intel Pentium processors or similar technology. More exotic but commonly available entry devices, such as OCR readers, touch screens, or voice recognition devices can also be used. Printers can be laser, ink jet, or line outputting devices.

The operating system software, programming languages, and database utilities used for data processing, storage, etc., are also known. The operating systems could be selected from UNIX, Windows, Windows 2000, Solaris, etc. The programming language used for the application software, which performs all of the subsystem logic, including such tasks as trading balancing, calculating instrument values at closing, keeping totals, controlling inputs/outputs, etc., could be C, C++, Basic, or a variety of others. A database such as that supplied by Oracle, Sybase, Informix, Microsoft or others will satisfactorily meet the needs of the system.

Communications among the various devices will depend upon the subsystems elected. In particular, intelligent devices within a local area can be connected by a local area network (LAN), such as that supplied by Microsoft or Novell, or, most probably, by using the Internet. Dissimilar devices in a local or wide area would, most probably, be connected, by standard TCP/IP technology. File servers that are needed could be standard Pentium or RISC based devices. Transmission among system elements can use Ethernet technology with standard Ethernet cards and 100BaseT lines, or token ring technology outside of common carrier domains. Standard high speed modems, multiplexors or direct digital transmission, such as by means of packet switching, can be used for long range transmission via the Internet, or less likely, through dedicated common carrier lines. Using a system according to the present invention, an investor could be in a trading establishment connected via a LAN, at home and connected by the Internet, en route and using mobile radio or cellular telephone, or in any location that has access to standard forms of communications.

In the preferred implementation, the predominant number of users will use the system over the Internet using browser technology, using secure transaction and encryption technologies. The users' PCs would be connected to a multi-tier central server that can be operated using a small support staff and with minimal human intervention. The users can see the changing prices of the Directional instruments and can trade them in real time. They can also track their present value. The software will support great numbers of transactions from a very large on-line user population. A current implementation of an analogous hardware system implemented in another industry supports 1.5 million users on-line simultaneously, and supports peak activity rates exceeding 5,000 transactions per second. This analogous hardware system also has the record keeping, accounting, analysis, reporting, and security features which would be required by the financial trading embodiment of the current invention.

Initial Pricing of Instruments

The trading system of the present invention includes an algorithmic methodology to initially price the instruments at the time of their creation. This initial (or “seed”) price may be dependent on the price of an underlying security or index that is related to the instrument.

It is convenient to first define some terms which will be used below:

S₀=the price of the underlying security at the time of creation of the instrument.

S_{c}=the price of the underlying security at the time the instrument is closed.

I=the intrinsic value of the instrument, if there is any, other than the value derived from the movement of the underlying security. For many instruments, including the Directional instruments (Ups and Downs) described previously, the intrinsic value is zero, but this may not be true for other types of instruments.

R=the number of instruments in a round lot, typically 100.

F=the desired commission fee for the trading firm of a round lot of the instrument. F may be a function of S₀(e.g. F=0.01*S₀*R), a more complex function, (e.g. F=Maximum [0.01 *S₀, $0.25]*R), or a constant value (e.g. F=$1.00*R).

Then, if U₀ represents the initial price of a round lot of Up instruments, and D₀ represents the initial price of a round lot of Down instruments:

U₀=(I*R)+F

D₀=(I*R)+F

How Price Movement of the Underlying Security Affects Price of Instrument

If the instrument is related to an underlying security, then the price of the instrument must be recalculated as the price of the underlying security moves in order to compensate for the increase or decrease of the initial intrinsic value (I) of the instrument. Several courses are now possible. The original Ups and Downs can continue to trade. The prices of each Up and Down would be recalculated to take into account the effect of a change in the underlying security upon the paper gains and losses of the Ups and Downs. For example, if the underlying security increased by 5 points, the Up instrument would increase in price by $500 (assuming a round lot of 100 instruments), and the Down instrument would decrease in price by the same $500. The recalculation of the prices of the original instruments may result in a “negative price,” which will provide a credit reducing the investor's required deposit (described subsequently).

The directional instruments could then continue to trade, with their prices recalculated as described above. This could, for example, allow participants to hedge out of a current instrument to secure an immediate gain, or limit a loss (this process is discussed in detail below). This permits gains to be immediately available for reinvestment. It will also serve to further stabilize portfolio value. Alternatively, new instruments could be created, with the old ones being closed to trading, but still live. Or both new and old instruments could trade, with the original instruments continuing in an after-market. However, having too many instruments available simultaneously might be confusing and/or lead to thin trading in each, with too rapid price changes resulting. The proper mix of new and old instruments will be easily determined after a period of use.

The trading system of the present invention includes an algorithmic methodology to determine the change in value for Directional instruments based on the price movement of the underlying security. If X represents the price movement of the underlying security relative to S₀ (X is a signed number, i.e., is negative if the price goes down) and S_{X} represents the price of the underlying security after a price movement of X has occurred, then:

S_{X}=S₀+X

Thus, for example, S₁ would represent the price of the underlying security when it has increased $1.00 from its initial value at the time of the instruments creation, and S_{-2.5} would represent the price when it has decreased $2.50 from its initial value.

If U_{X} represents the price of an Up instrument when the price of the underlying security is S₀ and D_{X} represents the price of a Down instrument when the price of the underlying security is S₀, then:

U_{X}=U₀+(X*R)

D_{X}=D₀−(X*R)

And if X_{c} represents the price movement of the underlying security at the time the instrument is closed, then:

S_{c}=S₀+X_{c}

Cost of Purchase and Value at Closing of Round Lot of the Instrument

The trading system of the present invention includes an algorithmic methodology to calculate the cost to the investor to purchase a round lot of the instrument, assuming no buying on margin, and the subsequent value of the instrument that is returned to the investor at the time the instrument is closed.

The variable M represents the maximum price movement (positive or negative) allowed in the underlying security. This is an arbitrary parameter set at the time the instrument is created, but may be related to S₀ (e.g. M=0.10*S₀). The instrument will be automatically closed out if the price of the underlying security becomes >=S_{M} or <=S_{-M} If this occurs, S_{c}is assumed to be equal to either S_{M} or S_{-M}, whichever is appropriate, even if the actual price of the underlying security exceeded the limit. If C_{U} represents the cost to the investor of a transaction to purchase N_{U} round lots of an Up instrument, and C_{D} represents the cost to purchase ND round lots of a Down instrument, at an arbitrary price U for a round lot, then:

C_{U}=(U+M*R)*N_{U}

C_{D}=(D+M*R)*N_{D}

Where the term M*R represents the deposit which the investor must put up to cover a potential increase (in the case of the Down) or decrease (in the case of the Up) of M dollars in the price of the underlying security.

If the variable V_{U} represents the value of N_{U} round lots of Up instruments if the instrument closes when the price of the underlying security is S_{c}, then V_{U} is given by the equation:

$$\begin{matrix}{V}_{U} = ( ( M * R ) + ( I + {S}_{c} - {S}_{0} ) * R ) * {N}_{U} \\ = ( M + I + {X}_{c} ) * R * {N}_{U}\end{matrix}$$

Where M*R is the return of the deposit.

Similarly, the value V_{D} of N_{D} round lots of Down instruments is given by the equation:

$$\begin{matrix}{V}_{D} = ( ( M * R ) + ( I + {S}_{0} - {S}_{c} ) * R ) * {N}_{D} \\ = ( M + I - {X}_{c} ) * R * {N}_{D}\end{matrix}$$

Where M*R is the return of the deposit.

Profit Analysis on a Single Transaction

Let P_{U}=the profit made by the securities firm (i.e. the operator of the system) from a transaction to purchase N_{U} round lots of an Up instrument at an arbitrary price U, which is subsequently closed when the price of the underlying security is S_{c}. This is equal to:

$$\begin{matrix}{P}_{U} = {C}_{U} - {V}_{U} \\ = ( ( U + M * R ) * {N}_{U} ) - ( ( M + I + {X}_{c} ) * R * {N}_{U} ) \\ = [ U - ( I + {X}_{c} ) * R ] * {N}_{U}\end{matrix}$$

Let P_{D}=the profit made by the securities firm from a transaction to purchase N_{D} round lots of a Down instrument at an arbitrary price D, which is subsequently closed when the price of the underlying security is S_{c}. This is equal to:

$$\begin{matrix}{P}_{D} = {C}_{D} - {V}_{D} \\ = ( ( D + M * R ) * {N}_{D} ) - ( ( M + I - {X}_{c} ) * R * {N}_{D} ) \\ = [ D + ( {X}_{c} - I ) * R ] * {N}_{D}\end{matrix}$$

Profit Analysis on Multiple Balanced Transactions

If we assume that an exactly equal number of Up and Down round lots are purchased (i.e. N_{D}=N_{U}=N), then the total profit P made by the securities firm is:

$$\begin{matrix}P = [ U - ( I + {X}_{c} ) * R ] * N + [ D + ( {X}_{c} - I ) * R ] * N \\ = ( U + D - 2 * I * R ) * N\end{matrix}$$

If we further assume that an equal number of Up and Down instruments were purchased at each price of the underlying security, then substituting for Uₓ and Dₓ yields:

P=[U₀+(X*R)+D₀−(X*R)−2*I*R]*N

Simplifying and substituting for U₀ and D₀ yields:

$$\begin{matrix}P = [ ( I * R ) + F + ( I * R ) + F - 2 * I * R ] * N \\ = 2 * F * N\end{matrix}$$

This condition of having equal numbers of round lots of Up and Down instruments purchased at synchronized prices, that is generated from the same S_{X} with no other adjustments, will be referred to as being “in balance.” It is observed that synchronized prices have the characteristic that U_{X}+D_{X}=2*(F+(I*R)). When the system is in balance, the trading firm will make as profit its desired commission fee on all round lots of Up and Down instruments, which we will refer to as the nominal profit (P_{N}). If the transactions are unbalanced, the profit will vary from the desired fees, and this variation is directly related to amount of unbalance. This variation could either be positive or negative, that is the trading firm can make more or less profit than expected. One of the goals of the system's algorithms is to limit the exposure to this variation of profits to within specified limits.

This variation of profit comes about when investors purchase unequal numbers of Up and Down instruments at the point in time when the underlying stock's price is at S_{X}. Subsequent to this unequal purchasing, several things can happen. If the instrument closes, the system will make or lose profit on the unbalanced round lots, based on whether they were Ups and Downs, and whether the price of underlying security moved higher or lower. If the instrument does not close, it is possible that the system will cover the unmatched purchases of one instrument (e.g. Ups) with subsequent purchases of the other security (e.g. Downs) at a non-synchronized price. Thus the numbers of round lots will be equal, but the non-synchronized prices will yield a profit that varies from the desired commission fee. This could happen repeatedly in the life of the instruments. Each of these cases will be analyzed independently for illustrative purposes, but in general, both cases would occur.

Profit Analysis of Instrument Closing with Unbalanced Lots Purchased

Assume that instruments are purchased when the price of the underlying security is S_{X} and that the instrument closes when the price of the underlying security is S_{C}. If the instruments close with unequal numbers of round lots of Ups and Downs purchased, then the profit can be described by the following equation:

$$\begin{matrix}P = [ {U}_{0} + ( X * R ) - ( I + {X}_{c} ) * R ] * {N}_{U} + [ {D}_{0} - ( X * R ) + ( {X}_{c} - I ) * R ] * {N}_{D} \\ = [ {U}_{0} - ( I * R ) + ( X - {X}_{c} ) * R ] * {N}_{U} + [ {D}_{0} - ( I * R ) - ( X - {X}_{c} ) * R ] * {N}_{D}\end{matrix}$$

Substituting for U₀ and D₀ yields:

$$\begin{matrix}P = [ F + ( X - {X}_{c} ) * R ] * {N}_{U} + [ F - ( X - {X}_{c} ) * R ] * {N}_{D} \\ = F * ( {N}_{U} + {N}_{D} ) + ( X - {X}_{c} ) * R * ( {N}_{U} - {N}_{D} )\end{matrix}$$

Since F*(N_{U}+N_{D}) is equal to the nominal profit on that number of round lots, the above equation can be rewritten as:

P=P_{N}+(X−X_{c})*R*(N_{U}−N_{D})

The above verifies that when the instrument closes, the system will make or lose profit on the unbalanced round lots, based on whether they were Ups and Downs, and whether the price of underlying security moved higher or lower.

When N_{U}>N_{D}, the minimum profit will occur when X_{c} is equal to M, and will be:

P=P_{N}−(M−X)*R*(N_{U}−N_{D})

When N_{D}>N_{U}, the minimum profit will occur when X_{c} is equal to −M, and will be:

P=P_{N}+(M+X)*R*(N_{U}−N_{D})

In order to reduce the exposure to loss of profit, it is necessary to reduce the imbalance.

Profit Analysis of Lots Purchased at Unsynchronized Prices (Hedging)

It will be appreciated that based on trading activity and changes in price of the underlying item, previously purchased Directional instruments can change in value prior to the expiration or close of the underlying put/call options. For example, say that a DJIA Up was purchased for $100 when the DJIA was 10,000 points. Should the DJIA move to 11,000 points, the DJIA Up now has an intrinsic value of $1,000. However, the holder of the instrument is exposed to risk that the value of the Up will go down before it expires. In this instance, a risk-averse holder of a DJIA Up might want to cash in his instrument for a sure $900 profit ($1,000 less the original cost of $100), rather than risk a reduction in his profit, or even a loss.

The holder of a Directional instrument which is “in the money” and who wants to “cash out,” cannot sell the instrument, but must wait for the instrument to close out. However, a Directional instrument can effectively be redeemed by buying the symmetric instrument at the current price. In the example above, the holder of the DJIA Up could hedge by buying an equal-sized lot of DJIA Downs with the same strike price and expiration date/time as his Up. It will be readily understood that all price movements in the DJIA Up and the DJIA Down subsequent to the purchase of the Down, will simply cancel each other out. The user can then simply wait until the Ups/Downs expire, and cash them in for a guaranteed profit (which will be the gross profit on the Up at the time the Down was purchased, less the cost of purchasing that Down as a hedge). By the same reasoning, a holder of a losing Directional instrument who does not want the risk of even greater than current losses, could at least lock in the current loss amount, thereby avoiding the risk of even greater losses.

It is clear from the explanation above that it is not strictly necessary for the holder of the DJIA Up and DJIA Down to wait for the instruments to close, since the financial result at closure is both calculable and predetermined regardless of future price movement. Accordingly, it is possible to have the trading system immediately credit the user for his locked-in profit (or debit the user for his locked-in loss) before the close of the Directional instruments.

The trading system of the present invention provides an algorithmic determination of the profit variation resulting from purchases at different prices. Let us assume that a number of round lots of one instrument (e.g. Ups) are purchased at a time when the price of the underlying security is S_{U}. The same number of round lots of the other instrument (e.g. Downs) is purchased when the price of the underlying security is S_{D}. The instruments subsequently close at a time when the price of the underlying security is S_{c}. The profit was shown previously to be given by the equation:

P=(U_{U}+D_{D}−2*I*R)*N

Substituting for U_{U} and D_{D}, and simplifying yields:

$$\begin{matrix}P = 2 * F * N + ( {X}_{U} - {X}_{D} ) * R * N \\ = {P}_{N} + ( {X}_{U} - {X}_{D} ) * R * N\end{matrix}$$

Thus it is demonstrated algebraically that the profit variation derived from purchases at unsynchronized prices is directly related to the difference between the prices. The profit variation due to equal purchases of N round lots made at unsynchronized prices cannot subsequently be changed by additional purchases. The additional purchases may increase or decrease overall profits based on the profit derived from these subsequent purchases, but the profit variation derived from the original N round lots is “locked in.”

These “locked in” profit variations (fixed profits/losses) for the trading firm would occur whether the matching Ups and Downs were purchased by the same investor attempting to hedge his position, or from different investors each acting independently.

Price Adjustments to Induce Balanced Purchases

It has been demonstrated above that when the system has an unbalanced number of round lots purchased, there is a potential for a large loss or profit by the trading house. This potential loss of profit is calculable, as is related to the size of the trading imbalance, and to the eventual price of the underlying security at the time of the instrument's close, which is bounded by S_{M} and S_{-M}. When faced with an unbalanced condition, the system can attempt to reduce or eliminate the potential loss of profit by inducing potential investors to purchase the instrument needed to bring the trading more into balance.

The system will do this by applying an adjustment to the prices of the Up and Down instruments. In general, the system would use a negative adjustment (−A₁) to the price of the instrument it wants to have purchased to order to decrease the price and to induce additional purchases. Similarly, the system could use a positive adjustment (+A₂) to the price of the instrument it does not want to have purchased to order to increase the price and to inhibit additional purchases or at least receive a higher price when one is purchased. There is no requirement that A₁ and A₂ be related; indeed one of them could be set equal to zero. However, for the remained of this analysis we will assume that their magnitudes are equal, that is: A₁=A₂.

This price adjustment should not be confused with the price recalculation described previously that was used to compensate for a change in the intrinsic values of the instruments. This price adjustment is used when there is no change to the intrinsic values of the instruments, but there exists a bias in the collective opinions of investors as to the potential for future up or down price movement of the underlying security that has led to the purchase of an unbalanced number of round lots.

The use of the price adjustments affects the equations previously defined; this is discussed in detail below.

Let A represent a price adjustment applied to the Up instrument. A is a signed number and maybe be either positive or negative. The choice of defining A in terms of the Up instrument is arbitrary, but results in no loss of generality. The price adjustment applied to the Down instrument is therefore −A.

If U_{XA} represents the price of an Up instrument when the price of the underlying security is S_{X}, with a price adjustment of A applied, then:

U_{XA}=U₀+(X*R)+A

If D_{XA} represents the price of a Down instrument when the price of the underlying security is S_{X}, with a price adjustment of −A applied, then:

D_{XA}=D₀−(X*R)−A

If an equal number of round lots are purchased using U_{XA} and D_{XA} they will be balanced and will produce the full nominal profit expected. This is so because U_{XA} and D_{XA} meet the criterion for synchronous prices since U_{XA}+D_{XA}=2*(F+(I*R)). However, it is preferable in this situation that unbalanced trading will ensue, where the imbalance will be in the opposite direction of the previous imbalance, thus reducing the overall unbalance and potential for loss of profit. However, matching round lots purchased prior to applying the price adjustment to round lots purchased with the price adjustment produces a loss of profit due to the “lots purchased at unsynchronized prices” phenomenon described previously. This loss can be shown to be A*N, where N is the number of round lots purchased at the adjusted price that are matched to round lots at the pre-adjusted price. Although the system has locked in a profit loss, this loss should be much smaller than the potential loss due to unbalanced action if the price of the underling security should move dramatically.

Many different algorithms could be used to produce the price adjustments. The system can be viewed as a feedback loop, since adjusting the price will produce a resultant investment pattern that can be measured and used to make additional adjustments. In the simplest case, price adjustments can be set equal to small constant increments, with multiple adjustments made sequentially until the desired investment pattern ensues. A more sophisticated approach involves making the price adjustment proportional to the degree of imbalance that must be overcome, larger price adjustments when the system is more unbalanced.

The degree of imbalance that must be overcome is not necessarily derived from only transactions that have already been completed. The system could maintain a list of pending purchase requests (the “book”). This book would consist of purchase requests made recently at the current price, but not yet executed. For certain types of instruments this book may also include limit orders, which are not to be executed unless the instrument reaches a pre-determined price. The algorithms that determine the appropriate price adjustment to make could also use the book of potential purchases to determine the degree of imbalance.

If it is determined that a price adjustment is appropriate, the book could also be used by other algorithms to determine if the system is willing to purchase all of the outstanding but not yet executed purchase requests at the old price (i.e. before the price adjustment), or whether all, or a portion of these purchase requests, should be rejected because the price is being changed to a new price (i.e. with the price adjustment).

To use these approaches, and to control the potential exposure the system has to negative profit variation, the system needs the ability to quantify this potential exposure after many transactions have occurred at various prices. This is the subject of the next section.

Quantifying Potential Exposure

Let us assume that the system is maintaining a book of not yet executed orders at the current price. For the purposes of this analysis, let us further assume that there are no limit orders. If it is desired to measure the impact on profits and potential exposure if these orders are executed, the system could treat these orders as if they were already executed, and include them along with the already executed transactions before making any mathematical calculations. If it is desired only to evaluate the current profit status of the already-executed transactions, obviously, the booked transactions should not be included. The collective term, “pool” is conveniently used to refer to a set of transactions. For the reminder of this discussion, when reference is made to “a pool” or “a pool's cumulative totals,” the “pool” might or might not include the booked transactions, dependent on the analysis being made.

Previous sections have presented the equations for calculating the profit from a balanced set of transactions, and the maximum potential profit exposure from unbalanced transactions. The system can therefore determine the profit and exposure for a pool of transactions by applying these equations to each transaction, and summing the results. However, this is a cumbersome technique. In addition, if there are unbalanced transactions, it raises the issue as to specifically which are the unbalanced transactions. Are they the last ones? The ones at the lowest purchased price? The highest? It would be better to be able to analyze the state of a pool by using cumulative totals that financially characterize the entire pool, rather than analyzing individual transactions.

Let C_{U} the cumulative cost to purchase all the Up instruments in the pool excluding the deposit (i.e. the term M*R) and the initial intrinsic value (i.e., the term I).

Let N_{U} the cumulative number of Up round lots in the pool

Let U_{A} the weighted average price paid for the Up instruments in the pool; then:

U_{A}=C_{U}/N_{U}

In a similar manner, C_{D}, N_{D} and D_{A} can be defined for the Down instruments.

Let N_{B}=the balanced portion of the pool; then

N_{B}=Minimum(N_{U}, N_{D})

It can be shown that P_{B}, the profit generated by the balanced portion of the pool is given by:

P_{B}=(U_{A}+D_{A})*N_{B}

If the current price of the underlying security is S_{X}, then the profit P_{UB} generated by the unbalanced portion of the pool is given by the following set of equations:

When N_{U}>N_{D}

P_{UB}=(U_{A}−X*R)*(N_{U}−N_{D})

When N_{D}>N_{U}

P_{UB}=(−D_{A}−X*R)*(N_{U}−N_{D})

The total profit expected if the pool were to close at this price can be found by adding P_{B} and P_{UB}.

The minimum profit that may be generated from the unbalanced portion of the pool (i.e. the exposure) is given by the following set of equations:

When N_{U}>N_{D}

P=(U_{A}−M*R)*(N_{U}−N_{D})

When N_{D}>N_{U}

P=(−D_{A}+M*R)*(N_{U}−N_{D})

Since it is easy to quantify both the pool's current profit picture and its worst-case profit exposure on the unbalanced trading, the system can limit the exposure to profit loss to within pre-defined limits. For example, the system could be configured, through appropriate selection of variable parameters, not to make less than 60% of the nominal profit. (Put another way, the system is willing to lose 40% of the nominal profit due to purchases at unsynchronized prices and unbalanced transactions.) Since the above analysis can be preformed before accepting the transactions in the book, the system can guarantee that this limit will not be violated by rejecting some or all of the pending orders, and making price adjustment(s) to try to induce a more balanced pool.

System Processing and Logic

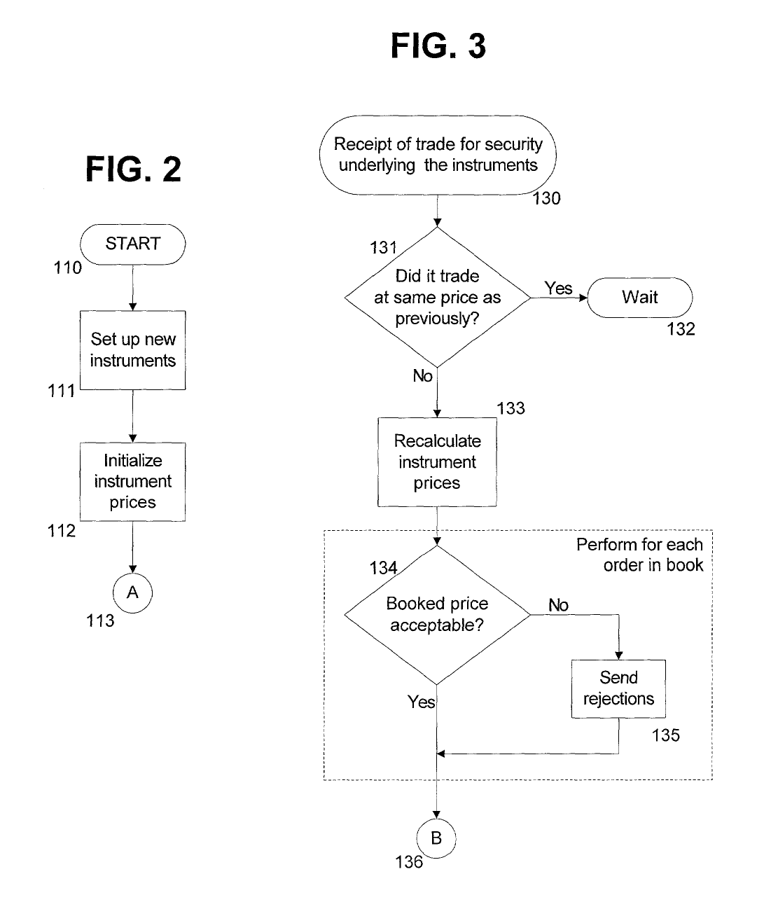

Having provided a general description of the system and a detailed discussion of the underlying algorithms, reference is now made to FIGS. 2 through 5, which are generalized logic flow diagrams of the processing of the trading system of the current invention.

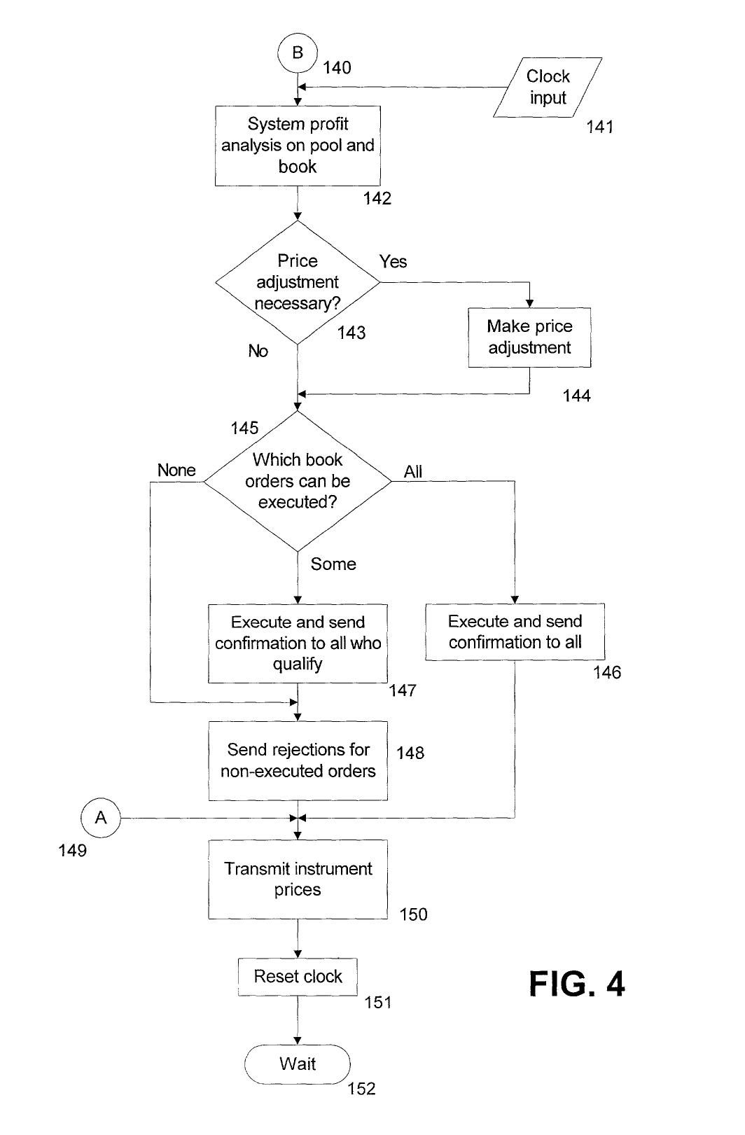

The system logic in the preferred embodiment works in the following manner. As shown in FIG. 2, the processing starts at block 110, and the first operation is to set up the new instruments in block 111, for example by aggregating pairs of puts and calls to set up the Directional instruments discussed above. The prices for these instruments are then initialized, for example using the algorithm discussed in the “Initial Pricing of Instruments” section above. The processing then passes (as indicated by blocks 113 and 149 in FIG. 4) to block 150, where the instrument prices (in this case, the initial prices) are transmitted to the users of the system. The system clock is reset at block 151, and as indicated at block 152, the system waits for the receipt of an order.

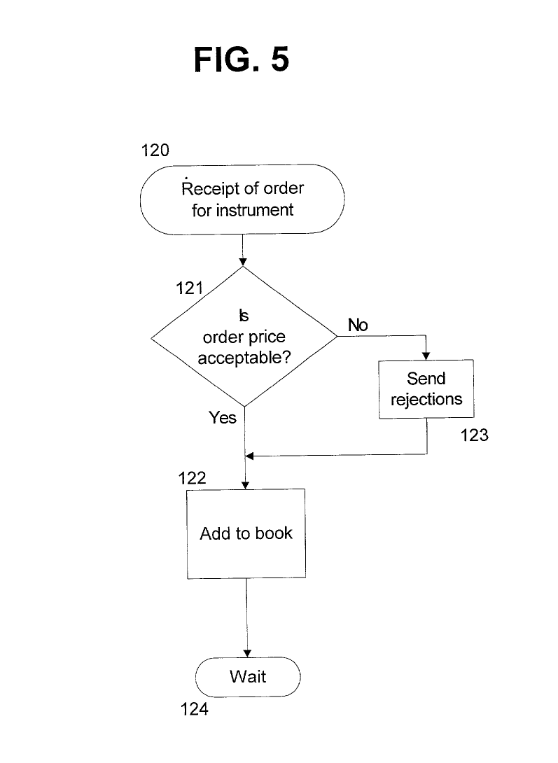

Order handling is shown in FIG. 5. Orders are received at block 120, and the effect of the order prices on trading balance are evaluated at block 121. If the price is acceptable, the order is added to the book at block 122, but if the price is not acceptable, the system sends a rejection message in block 123. The system then waits for further orders, as indicated in block 124.

The processing to evaluate price changes in the underlying security is shown in FIG. 3. If it is determined in block 130 that there has been a transaction involving the security underlying the instrument, then processing proceeds to block 131, where a test is done whether the trading price of that security was the same as the previous trade. If so, no response by the system is required, as shown by block 132. If the underlying security's price has changed, then the instrument prices are recalculated (as discussed in detail in the relevant section above) in block 133. Then, for each instrument order in the book (i.e., each pending order), a determination is made at block 134 whether the price at which the order was placed is still acceptable. A rejection message is sent in block 134 for any booked order which was not acceptable.

Processing then passes (through blocks 136 (in FIG. 3) and 140 (in FIG. 4)) to block 142, where the system performs a profit analysis on the pool and the book (as discussed in detail in the profit analysis sections above). Based on the results of the profit analysis, and the predetermined financial exposure limits, the system determines in block 143 whether the trading is excessively unbalanced, such that an adjustment in the price of the instruments is required. If so, the appropriate adjustment is made in block 144 to induce orders which will bring the trading back into balance.

The system then determines, in block 145, whether it can execute some or all of the booked orders. If so, those orders are executed and confirmation messages are sent to all users whose orders qualified for execution (in blocks 146 and 147). If any orders cannot be executed, rejection messages are sent in block 148 to all users whose orders were rejected.

The processing then passes to block 150, where the instrument prices (which may no longer be the same as the initial prices) are transmitted to the users of the system. The system clock is reset at block 151, and as indicated at block 152, the system waits for the receipt of an order.

It will be understood by those skilled in the art that the foregoing represents merely sample embodiments of the invention and that a myriad of modifications and alternative implementations are possible without departing from the basic intent or scope of the present invention. For example, although Ups and Downs have been extensively discussed as examples of Directional instruments, the present invention is more generally directed to any Directional instrument which has the characteristics of: (i) having a price which moves in correlation with the price of the underlying item (thus effectively allowing investment in price movement) and (ii) improved financial leverage as compared to investing directly in the underlying security. Another example of an instrument that allows leveraged trading in the movement of an underlying security is the trading of futures contracts on securities which are required to be cashed out at a specific expiration date/time. Furthermore, although the examples have focused on the trading of Directional instruments, the novel trading system above is also applicable to known financial instruments including stocks, bonds, currency and other fungible items which are sold in a market. Also, although the examples only consider round lots, odd lots might also be sold and be accumulated until they comprise a round lot.

Furthermore, the system and method of the present invention may be used purely for entertainment purposes, such that users of the system or method are not exposed to any financial risk. This is accomplished by simulating the transactional environments described above, and allowing users to participate in the simulation by pretending that they are entering into the corresponding financial transactions. In this case, rather than winning or losing actual dollars, users would be winning or losing imaginary dollars or “points.” The users would simply be playing a game, attempting to win by amassing the most points.

What is claimed is:

1. A method of trading investment instruments relating to an underlying security comprising the steps of:
(a) creating an Up instrument by aggregating: (i) the purchase of a round lot of call options for the underlying security at a specified strike price and specified expiration date/time, and (ii) the sale of a round lot of put options for the same underlying security at the same strike price and same expiration date/time;
(b) creating a Down instrument by aggregating: (i) the purchase of a round lot of put options for the underlying security at a specified strike price and specified expiration date/time, and (ii) the sale of a round lot of call options for the same underlying security at the same strike price and same expiration date/time;
(c) calculating an opening sale price for the Up and Down instruments;
(d) opening the Up and Down instruments to trading at their opening sale prices;
(e) monitoring the sales of the Up and Down instruments, including monitoring at least the imbalance in the trading volume of Up and Down instruments;
(f) adjusting the sale price of the Up and Down instruments based at least in part on information collected in the monitoring step; and
(g) recalculating the sale price of the Up and Down instruments based at least in part on movement of the price of the underlying security.
